(19) United States
(12) Patent Application Publication
(10) Pub. No.: US 2003/0084315 A1
(43) Pub. Date: May 1, 2003

(54) System and method for controlled access

(76) Inventors: Neal A. Krawetz, Fort Collins, CO (US); Jeffrey D. Schwartz, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/999,465

(22) Filed: Oct. 30, 2001

(51) Int. Cl. H04L 9/32

(52) U.S. Cl. 713/200

(57) ABSTRACT

A system for controlled access comprises a processor, a memory accessible by the processor, an index application stored in the memory and executable by the processor, and an entry application stored in the memory and executable by the processor. The memory comprises an identifier associated with granting access. The identifier comprises a plurality of fields. The index application is adapted to randomly generate an index field identifying one of the plurality of fields. The entry application is adapted to request from a user at least a portion of the identifier beginning with the index field.

### TECHNICAL FIELD OF THE INVENTION

The present invention relates generally to the field of security systems and methods and, more particularly, to a system and method for controlled access.

### BACKGROUND OF THE INVENTION

Information stored on computers is oftentimes secured or protected from unauthorized access. For example, financial, personal, corporate, and other types of confidential or sensitive information are generally protected from unauthorized access. Additionally, access to particular software applications may be restricted because of licensing or other concerns. Security methods may also be used to control access to buildings, rooms, or other types of structures or areas. For example, access to buildings or rooms containing sensitive or proprietary products or information is often desired. Passwords, personal identification numbers (PINs), and other types of security measures are generally used to restrict access to such confidential, sensitive, or restricted information or areas.

However, passwords, PINs, and other type of similar access methods generally provide limited security. For example, users often select passwords or PINs that reflect familiar dates or terms, such as birthdays or names of family members. Additionally, the length of a password or PIN is generally limited to a quantity of fields or digits that is easy to memorize and remember. Accordingly, passwords or PINs may be easy to crack or obtain, for example, by utilizing various iterative-based software programs.

### SUMMARY OF THE INVENTION

In accordance with one embodiment of the present invention, a method for controlled access comprises storing an identifier associated with granting access. The identifier comprises a plurality of fields. The method also comprises receiving a request from a user for access and randomly generating an index field. The index field identifies one of the plurality of fields. The method further comprises requesting from the user at least a portion of the identifier beginning with the index field.

In accordance with another embodiment of the present invention, a system for controlled access comprises a processor, a memory accessible by the processor, an index application stored in the memory and executable by the processor, and an entry application stored in the memory and executable by the processor. The memory comprises an identifier associated with granting access. The identifier comprises a plurality of fields. The index application is adapted to randomly generate an index field identifying one of the plurality of fields. The entry application is adapted to request from a user at least a portion of the identifier beginning with the index field.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating a system for controlled access in accordance with an embodiment of the present invention;

FIG. 2 is a diagram illustrating an example identifier of the system illustrated in FIG. 1 for controlled access in accordance with an embodiment of the present invention; and

FIG. 3 is a flow chart illustrating a method for controlled access in accordance with an embodiment of the present invention.

### DETAILED DESCRIPTION OF THE DRAWINGS

The preferred embodiments of the present invention and the advantages thereof are best understood by referring to FIGS. 1 through 3 of the drawings, like numerals being used for like and corresponding parts of the various drawings.

FIG. 1 is a diagram illustrating a system 10 for controlled access in accordance with an embodiment of the present invention. It should be understood that system 10 may be incorporated into a variety of applications within the scope of the present invention. For example, system 10 may be incorporated into a desktop computer, a financial transaction device, such as an automated teller machine or credit card device, a personal digital assistant, a building security system, and a variety of other types of devices, applications, or systems for which control of access is desired.

In the illustrated embodiment, system 10 comprises an input device 12, an output device 14, a processor 16, a database 18, and a memory 20. Input device 12 may comprise a keyboard, key pad, a pointing device such as a mouse, a track pad, or other type of device for inputting information into system 10. Output device 14 may comprise a monitor, display, printer, or other type of device for generating an output.

The present invention also encompasses computer software that may be stored in memory 20 and executed by processor 16. In this embodiment, memory 20 comprises an entry application 30 and an index application 40, which are computer software programs. In FIG. 1, entry application 30 and index application 40 are illustrated as being stored in memory 20, where they can be executed by processor 16.

Database 18 comprises information associated with controlling access to a computer system, location, or other security application. In the illustrated embodiment, database 18 comprises entry data 50 and verification data 52 used by entry application 30 and index application 40 for granting or denying such access. In the illustrated embodiment, entry data 50 comprises an identifier 60 that in turn comprises information required to be provided by a user of system 10 to obtain such access including, but not limited to, a password or a personal identification number (PIN). For example, in the illustrated embodiment, identifier 60 comprises a character string 70, which may comprise a combination of alphanumeric characters and/or symbols of a particular length or having a particular quantity of fields.

Verification data 52 comprises information associated with verifying and/or authorizing the requested access. In the illustrated embodiment, verification data 52 comprises an index field 80 and a field quantity 82. Index field 80 comprises one of the fields of identifier 60 randomly identified by index application 40. For example, index field 80 may comprise one of the fields of character string 70 identified by index application 40. Field quantity 82 comprises a randomly generated quantity of the fields of identifier 60 required to be input from a user desiring access.

Briefly, in operation, entry application 30 comprises an interface for receiving information from a user of system 10 desiring access. For example, entry application 30 may reflect a login or other information-gathering interface adapted to receive information from the user via input device 12. Entry application 30 may be adapted to request identifier 60 from the user after receiving various information corresponding to the user, such as a username or the like, or may be adapted to display a plurality of fields for receiving such information and identifier 60 from the user. Identifier 60 may also be configured such that each identifier 60 stored in system 10 uniquely identifies a particular user, thereby obviating a requirement for any additional information. Accordingly, system 10 may be variously configured to accommodate a variety of applications.

Index application 40 randomly generates index field 80 corresponding to identifier 60 in response to a request for access by the user. For example, if character string 70 comprises ten fields, index application 40 randomly identifies one of the ten fields of character string 70 as index field 80. In operation, to obtain the requested access, the user must input identifier 60 beginning with the identified index field 80. Thus, for each access request, index application 40 randomly identifies the required beginning field of identifier 60 to be input by the user to obtain the desired access, thereby increasing the security level associated with identifier 60.

Index application 40 also randomly generates field quantity 82 in response to a user's request for access. For example, as briefly described above, character string 70 may comprise a particular quantity of fields, for example, such as ten fields. Index application 40 randomly identifies a particular number or quantity of the fields required to be input by the user to obtain the desired access. For example, if character string 70 comprises ten fields, index application 40 may randomly determine that five of the ten fields of character string 70 are required to be input by the user to obtain the desired access. Entry application 30 may be adapted to provide or display to the user requesting the access the index field 80 and field quantity 82. Thus, in the above-described example, a user desiring access must input into entry application 30 the alphanumeric characters and/or symbols of character string 70 beginning with the identified index field 80 and including field quantity 82 identified by index application 40.

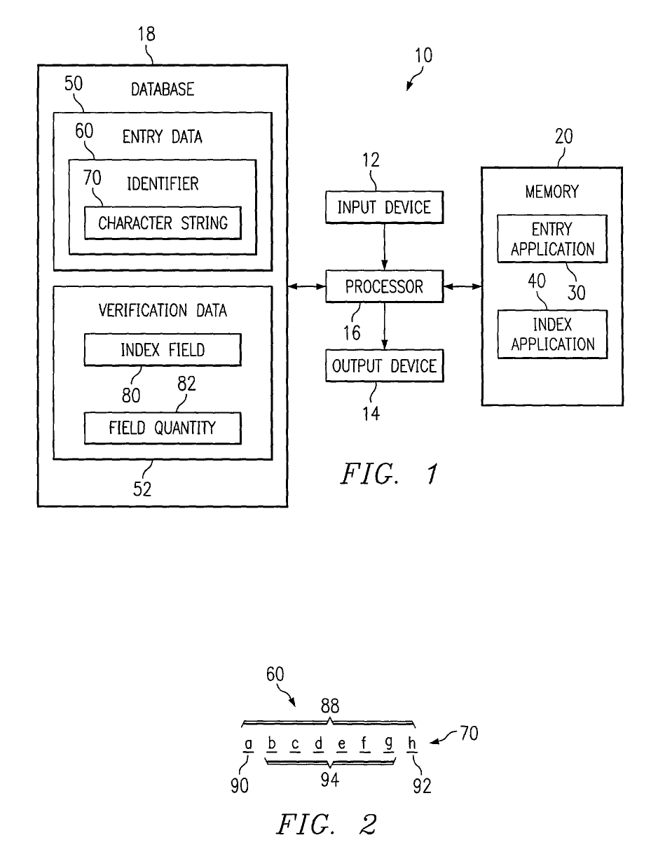

FIG. 2 is a diagram illustrating an example identifier 60 of system 10 illustrated in FIG. 1 in accordance with an embodiment of the present invention. In the illustrated embodiment, identifier 60 comprises character string 70 which, in this example, comprises eight fields 88 and reciting “abcdefgh.” Character string 70 in the illustrated embodiment comprises a start field 90, identified by the letter “a,” an end field 92, identified by the letter “h,” and a plurality of intermediate fields 94. However, it should be understood that identifier 60 may have a greater or lesser quantity of fields 88 and comprise a variety of other types of characters.

In operation, index application 40 randomly identifies one of the fields 88 as index field 80. The user must then input identifier 60 beginning with the identified index field 80. For example, index application 40 may randomly identify the fourth field 88, identified by the letter “d,” as index field 80 in response to a request for access by the user. The user must then input identifier 60 beginning with the fourth field 88 to obtain the desired access. Thus, in the present example, the user must input identifier 60 beginning with “d” (i.e., “defghabc”) to obtain the desired access. As will be described below in greater detail, the remaining fields 88 of identifier 60 required to be input by the user to obtain the desired access may be varied.

System 10 may be adapted to require all of fields 88 of identifier 60 to be input by the user in accordance with a particular order. Thus, the user may be required to input the portions of identifier 60 disposed before and after the identified index field 80 and beginning with index field 80 to obtain the desired access. For example, system 10 may be adapted to require the user to input the portion of identifier 60 disposed after index field 80 followed by the remaining portion of identifier 60 disposed before index field 80. Thus, in the above-described example, if the identified index field 80 is the fourth field 88, the required input from the user would comprise “defghabc.”

Further, for example, system 10 may be adapted to require various portions of identifier 60 to be input by the user in a particular order to obtain the desired access. For example, depending on the location of the identified field 88 as index field 80, a portion of identifier 60 will be disposed before and/or after the identified index field 80. System 10 may be adapted to randomly identify those portions of identifier 60 required to be input by the user to obtain the desired access. For example, system 10 may be adapted to require the portion of identifier 60 disposed after index field 80 to be input by the user, therefore, beginning with index field 80 and continuing through to end field 92. Thus, in the above-described example, if the fourth field 88 is identified as index field 80, the required input by the user would comprise “defgh.”

Accordingly, system 10 may be adapted to require a variety of input requirements from a user to obtain the desired access. As illustrated in FIG. 2, the illustrated identifier 60 comprises a sequential character string 70 reciting “abcdefgh.” In the above-described examples, the required input by the user to obtain the desired access requires sequentially reciting identifier 60 beginning with the identified index field 80 and continuing through various portions of identifier 60. However, it should be understood that particular fields 88 of identifier 60 may also be randomly identified by index application 40 required to be input by the user to obtain the desired access, thereby resulting in a nonsequential recitation of various portions of identifier 60. For example, index application 40 may randomly identify the second, fourth, sixth, and followed by the first fields 88 of identifier 60 to be recited by the user desiring access. Thus, in this example, the user may be required to recite “bdfa” to obtain the desired access. Entry application 30 may be correspondingly adapted to display the field 88 numbers corresponding to index field 80 and other required fields 88 via output device 14.

Index application 40 may also randomly identify field quantity 82 required to be recited by the user desiring the access. For example, index application 40 may identify the second field 88, identified in FIG. 2 by the letter “b,” as index field 80 and randomly identify a quantity of five as field quantity 82. Thus, in this example, the user desiring access would be required to input “bcdef” as identifier 60. Additionally, entry application 30 may illustrate or display a relatively large quantity of available fields 88 for receiving the input identifier 60, thereby including a greater number of fields 88 than is required to be recited by the user. Thus, the user may be required to input with particularity the designated field quantity 82 to obtain the desired access.

Further, for example, index application 40 may randomly identify field quantity 82 greater than a number of fields 88 of the identifier 60 while requiring various characters of the identifier 60 to be repeated to obtain the desired access. For example, index application 40 may randomly identify the fourth field as index field 80, identified in FIG. 2 as the letter “d,” and randomly identify a quantity of ten as field quantity 82. Thus, in this example, the user desiring access would be required to input “defghabcde” as identifier 60. Therefore, the qnatity of fields 88 of identifier 60 required to be input by the user may be greater than the quantity of fields corresponding to identifier 60, thereby requiring the user to repeat various fields 88 of identifier 60.

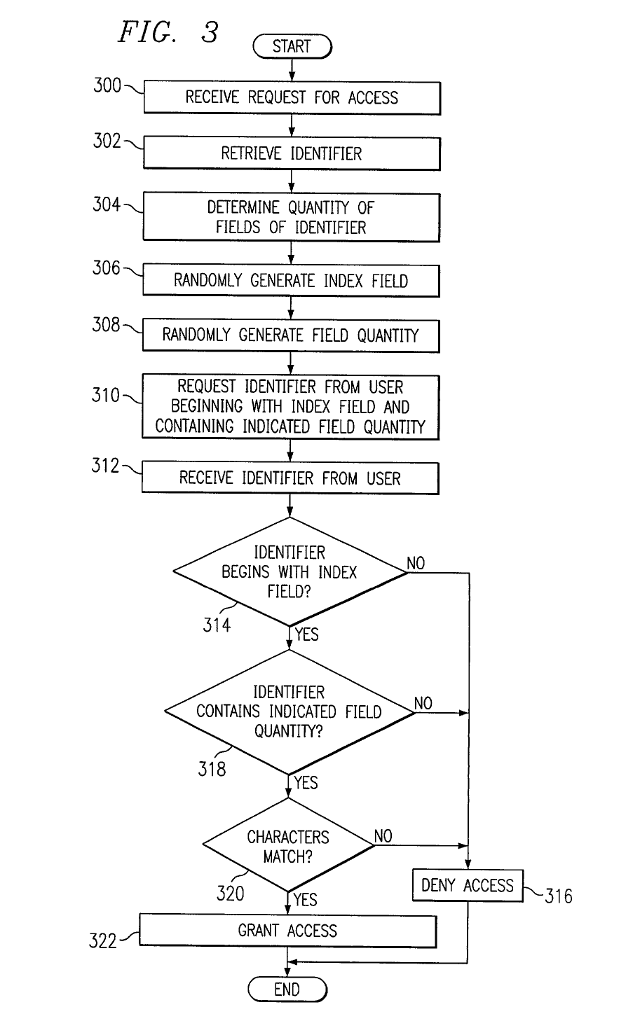

FIG. 3 is a flow chart illustrating a method for controlled access in accordance with an embodiment of the present invention. The method begins at step 300, where a request for access may be received from a user. For example, entry application 30 may display one or more views, screens, or other graphical interface displays for receiving information from the user requesting access. At step 302, index application 40 retrieves identifier 60 from database 18. At step 304, index application 40 determines the quantity of fields 88 corresponding to identifier 60. As described above, identifier 60 corresponds to information required to be input by the user to obtain the desired access.

At step 306, index application 40 randomly generates index field 80 identifying one of the fields 88 of identifier 60. At step 308, index application 40 randomly generates field quantity 82 identifying a particular quantity of fields 88 of identifier 60 required to be input by the user. As described above, to obtain the desired access, the user must generally input the field quantity 82 identified by index application 40 beginning with index field 80 corresponding to identifier 60 to obtain the desired access.

At step 312, entry application 30 receives information from the user desiring access corresponding to identifier 60. At decisional step 314, a determination is made whether the input information begins with index field 80 identified by index application 40. If the input information does not begin with index field 80, the method proceeds to step 316, where the requested access is denied. If the input information does begin with index field 80, the method proceeds from step 314 to decisional step 318. At decisional step 318, a determination is made whether the input information contains the field quantity 82 identified by index application 40. If the input information does not contain the field quantity 82 identified by index application 40, the method proceeds from step 318 to step 316, where the requested access is denied. If the input information does contain the designated field quantity 82, the method proceeds from step 318 to decisional step 320.

At decisional step 320, a determination is made whether the information input from the user matches the required fields 88 of identifier 60. For example, as described above, identifier 60 may comprise a series of alphanumeric characters and/or symbols. If the information input by the user does not match the corresponding information of identifier 60, the method proceeds from step 320 to step 316, where the requested access is denied. If the information input by the user does match the information corresponding to identifier 60, the method proceeds from step 320 to step 322, where the desired access is granted.

It should be understood that in the described method, certain steps may be omitted or accomplished in a sequence different from that depicted in FIG. 3. For example, step 308 of randomly generating field quantity 82 may be accomplished prior to step 306 of randomly generating index field 80, or steps 306 and 308 may be performed simultaneously. Also, it should be understood that the method depicted in FIG. 3 may be altered to encompass any of the other features or aspects of the invention as described elsewhere in the specification.

What is claimed is:

1. A method for controlled access, comprising:
storing an identifier associated with granting access, the identifier having a plurality of fields;
receiving a request from a user to receive access;
randomly generating an index field, the index field identifying one of the plurality of fields; and
requesting from the user at least a portion of the identifier beginning with the index field.

2. The method of claim 1, wherein the plurality of fields comprises a start field and an end field.

3. The method of claim 2, further comprising granting access if the identifier received from the user begins with the index field and ends with the end field.

4. The method of claim 1, further comprising granting access if the identifier received from the user begins with the index field and recites all of the plurality of fields.

5. The method of claim 1, wherein the plurality of fields comprises a first portion disposed before the index field and a second portion disposed after the index field.

6. The method of claim 5, further comprising granting access if the identifier received from the user begins with the index field and recites the second portion followed by the first portion.

7. The method of claim 1, further comprising randomly determining a quantity of the fields of the identifier required to be provided by the user to receive access.

8. The method of claim 7, further comprising granting access if the identifier received from the user begins with the index field and recites the quantity of the fields.

9. The method of claim 7, wherein a quantity of the fields required to be provided by the user to receive access is greater than a quantity of the fields corresponding to the identifier.

10. A system for controlled access, comprising:
a memory accessible by a processor, the memory comprising an identifier associated with granting access, the identifier comprising a plurality of fields;
an index application stored in the memory and executable by the processor, the index application adapted to randomly generate an index field identifying one of the plurality of fields; and
an entry application stored in the memory and executable by the processor, the entry application adapted to request from a user at least a portion of the identifier beginning with the index field.

11. The system of claim 10, wherein the index application is further adapted to randomly determine a quantity of the fields requested to be provided by the user to grant access.

12. The system of claim 10, wherein the identifier comprises a first portion disposed before the index field and a second portion disposed after the index field.

13. The system of claim 12, wherein the entry application is adapted to grant access if the user provides the identifier beginning with the index field followed by the second portion.

14. The system of claim 12, wherein the entry application is adapted to grant access if the user provides the identifier beginning with the index field followed by the second portion and then the first portion.

15. The system of claim 10, wherein the entry application is adapted to grant access if the identifier received from the user begins with the index field and recites all of the plurality of fields.

16. The system of claim 10, wherein the plurality of fields comprises a start field and an end field.

17. The system of claim 16, wherein the entry application is adapted to grant access if the identifier received from the user begins with the index field and ends with the end field.

18. The system of claim 10, wherein the index application is further adapted to randomly determine a quantity of the fields requested to be provided by the user to receive access, and wherein the entry application is further adapted to grant access if the user provides the identifier beginning with the index field and having the required quantity of fields.

19. The system of claim 18, wherein the quantity of the fields required to be provided by the user is greater than a quantity of the fields corresponding to the identifier.

20. A method for controlled access, comprising:
randomly generating an index field identifying one of a plurality of fields of a first identifier, the first identifier required for granting access;
receiving at least a portion of a second identifier from a user desiring access; and
granting the access if the second identifier begins with the index field and matches a corresponding portion of the first identifier.

21. The method of claim 20, further comprising randomly selecting a quantity of the fields of the first identifier required for access.

22. The method of claim 21, wherein granting further comprises granting the access if the second identifier begins with the index field and matches a corresponding quantity of fields of the first identifier.

23. The method of claim 20, wherein the first identifier comprises a start field and an end field.

24. The method of claim 23, wherein granting further comprises granting the access if the second identifier matches a portion of the first identifier beginning with the index field and ending with the end field.

25. The method of claim 20, wherein the first identifier comprises a first portion disposed before the index field and a second portion disposed after the index field.

26. The method of claim 25, wherein granting further comprises granting the access if the second identifier matches the first identifier beginning with the index field followed by the second portion and then the first portion.

27. The method of claim 20, wherein the first identifier comprises a sequence of alphanumeric characters.

28. The method of claim 27, wherein granting further comprises granting the access if the second identifier matches the first identifier beginning with the index field and sequentially reciting all of the corresponding alphanumeric characters of the first identifier.

29. The method of claim 20, further comprising randomly selecting a quantity of the fields of the second identifier required for granting the access.

30. The method of claim 29, further comprising requesting the second identifier from the user beginning with the index field and reciting the selected quantity of the fields.

31. The method of claim 29, wherein the quantity of fields of the second identifier required for granting the access is greater than a quantity of fields corresponding to the first identifier.
